(19) United States
(12) Patent Application Publication
(10) Pub. No.: US 2022/0009047 A1
(43) Pub. Date: Jan. 13, 2022

(54) METHOD FOR MACHINING CFRP USING MACHINING PATH AND MACHINING ORDER IN VIEW OF JIG ARRANGEMENT AND MACHINING EQUIPMENT HAVING FLEXIBLE JIG DEFORMATION PREVENTING STRUCTURE APPLIED THERETO

(71) Applicant: KOREA INSTITUTE OF INDUSTRIAL TECHNOLOGY, Cheonan-si, Chungcheongnam-do (KR)

(72) Inventors: Tae Gon KIM, Seongnam-si, Gyeonggi-do (KR); Hyo Young KIM, Anseong-si, Gyeonggi-do (KR); Seok Woo LEE, Seongnam-si, Gyeonggi-do (KR)

(73) Assignee: KOREA INSTITUTE OF INDUSTRIAL TECHNOLOGY, Cheonan-si, Chungcheongnam-do (KR)

(21) Appl. No.: 17/295,359

(22) PCT Filed: Nov. 18, 2019
(86) PCT No.: PCT/KR2019/015748

§ 371 Date: May 19, 2021

(30) Foreign Application Priority Data
Nov. 19, 2018 (KR) 10-2018-0142592
Nov. 20, 2018 (KR) 10-2018-0143650

(51) Int. Cl. B23Q 15/12; B23Q 3/06

(52) U.S. Cl. CPC B23Q 15/12; B23Q 3/06

(57) ABSTRACT

Provided is a machining method for improving machining quality for a machining target by minimizing vibrations occurring during machining of each machining region, deformation of a shape of the machining region, and a position error of the machining region by selecting a machining path in consideration of the number of fixing jigs and a distance between jigs at each machining region. A method for machining a carbon fiber reinforced plastic (CFRP) using a machining path and a machining order in view of a jig arrangement includes i) an operation in which shape data of a machining target is input to a controller ii) an operation in which a position of each of a plurality of flexible jigs is controlled, iii) an operation in which when the machining target is seated on the flexible jig, position information of the machining target in contact with each of the flexible jigs is generated and transferred to the controller, iv) an operation in which the controller generates a machining path according to a start machining region and a machining order for the machining target by comparing the input position of the flexible jig with position and shape data of the machining target, and v) performing machining, by a tool, on the machining target.

### BACKGROUND OF THE DISCLOSURE

### Field of the disclosure

The present disclosure relates to a method for machining carbon fiber reinforced plastic (CFRP) and machining equipment using a machining path and machining order in view of a jig arrangement, and more particularly, to a machining method for improving machining quality for a machining target by minimizing vibrations occurring during machining of each machining region, deformation of a shape of the machining region, and a position error of the machining region by selecting a machining path in consideration of the number of fixing jigs and a distance between jigs at each machining region, and machining equipment including a flexible jig deformation preventing structure applied thereto including an auxiliary support portion supporting a workpiece to be machined to prevent a reduction in bearing powder of a machining support portion.

### Related Art

In the case of performing a machining process on a machining target (an object or a target to be machined) using a computer numerical control (CNC) machine tool or a robot, it is necessary to set a machining start point for the machining target and create a machining path. To this end, it is common to seat the machining target on a flexible jig and then place a probe, which is a probing element, on the machining target to set a machining origin of the machining target.

However, if a fixing force of the flexible jig is lower than that of a machining load, the related art described above is inadequate to cope with a change in position and shape of the machining target during machining, and thus machining accuracy of the machining target decreases.

Meanwhile, in the case of machining a curved structure forming a curved surface, a plurality of jigs are provided to stably support the structure to correspond to the curved surface. Specifically, the curved structure may escape from the jigs due to gravity or a machining force so as to be damaged or precise machining may not be performed on the curved structure, involving a possibility of an occurrence of a machining error.

And, when machining is performed, if a jig does not exist below a machining position, the curved structure may be deformed due to the machining force. Therefore, in the related art, vacuum equipment is provided in the jig below the curved structure to improve fixing power of the structure.

However, since such a jig is formed of rubber or silicone material for sealing force, a workpiece is deformed due to escape according to machining due to low rigidity of rubber or silicone.

Korean Patent Registration No. 10-0906726 (Title of the invention: Jig device for positioning workpiece of machine tool) discloses a jig device for positioning a workpiece of a machine tool including a horizontal bar 2 slidably coupled to a bed 110 of a machine tool such as a milling machine so as to be selectively fixed to a specific position along a left-right direction of the bed; a vertical bar 8 erected and fixed on the horizontal bar 2 and having a first bolt hole 10 formed at the center in the left-right direction of the bed; an extending bar including a second bolt hole 20 formed in the left-right direction of the bed, fixed by an adjustment bolt 18 in a state of being in surface contact with the vertical bar 8 and having a pinhole 22 formed in the left-right direction of the bed; and a bar-shaped setting pin 24 inserted with a certain length into the pinhole 22 and fixed thereto so that a front end 24a thereof is in contact with a side surface of a workpiece.

### RELATED ART DOCUMENT

Korean Patent Registration No. 10-0906726

Korean Patent Laid-Open Publication No. 10-2016-0060552

Korean Patent Registration No. 10-1789673

Korean Patent Registration No. 10-1671736

Korean Patent Registration No. 10-1864718

Korean Patent Registration No. 10-1759178

Korean Patent Registration No. 10-1843860

Korean Patent Registration No. 10-1709577

Korean Patent Registration No. 10-1864751

Korean Patent Registration No. 10-1717629

Korean Patent Registration No. 10-1665935

### SUMMARY

The present disclosure is to separate each machining range of a machining target and form a machining path in consideration of characteristics of each machining range.

The present disclosure also provides machining equipment including a flexible jig deformation preventing structure applied thereto capable of stably performing machining including an auxiliary support portion supporting a workpiece to prevent a reduction in bearing force of a machining support portion, so that machining is performed stably by supporting the workpiece through the auxiliary support portion, even if bearing power of the machining support portion is reduced.

The technical problem to be achieved by the present disclosure is not limited to the technical problem mentioned above, and other technical problems that are not mentioned may be clearly understood by a person skilled in the art to which the present disclosure pertains from the following description.

In an aspect, a method for machining a carbon fiber reinforced plastic (CFRP) using a machining path and a machining order in view of a jig arrangement includes: i) an operation in which shape data of a machining target is input to a controller; ii) an operation in which a position of each of a plurality of flexible jigs is controlled; iii) an operation in which when the machining target is seated on the flexible jig, position information of the machining target in contact with each of the flexible jigs is generated and transferred to the controller; iv) an operation in which the controller generates a machining path according to a start machining region and a machining order for the machining target by comparing the input position of the flexible jig with position and shape data of the machining target; and v) performing machining, by a tool, on the machining target, wherein, in the operation iv), the controller transfers a control signal to the tool 30 so that machining may be performed, starting from a machining region in which the smallest vibration occurs, when each machining region of the machining target is machined.

In operation iv), the machining region in which the smallest vibration occurs may be determined using the number of fixing jigs, which is the number of the flexible jigs, surrounding the machining region and a jig separation distance which is a distance between the machining region or each of the flexible jigs and the machining region.

In operation i), in the operation of inputting data of the machining target, the data of the machining target may be designed by a CAD program.

In operation ii), in a state in which the machining target is seated on the plurality of flexible jigs, positions of X, Y, and Z axes of each of the flexible jigs may be formed as coordinates and input to the controller.

The machining target may include at least one of carbon fiber reinforced plastic (CFRP), metal, or a synthetic resin having a freeform surface shape.

In operation v), a machining process for the machining target may include at least one of milling, drilling, trimming, water jet, or routing.

Operation iv) may include an error detection operation of detecting an error of a machining process by comparing the shape data of the machining target with designed data on coordinates in contact with the flexible jig.

Operation iv) may include a deformation correction operation of correcting a deformation of the machining target during a machining process.

In the deformation correction operation, a machining load and vibration may be measured using the flexible jig, and a deformation of the machining target due to the machining load and the vibration may be corrected.

In another aspect, a CFRP machining apparatus of the present disclosure includes: a tool performing machining on a machining target; a flexible jig allowing the machining target to be seated thereon and supporting the machining target, and varied in length to change a position of the machining target; a driver coupled to a plurality of flexible jigs and changing a position of each of the flexible jigs; and a controller transferring a control signal to the flexible jig, the driver, or the tool and receiving shape data for the machining target, wherein the controller transfers a control signal to the tool 30 so that machining may be performed, starting from a machining region in which the smallest vibration occurs, when each machining region of the machining target is machined.

The controller generates a machining path according to a start machining region and a machining order for the machining target by comparing the input position of the flexible jig with position and shape data of the machining target.

In another aspect, a machining equipment including a flexible jig deformation preventing structure applied thereto includes: a base portion to which a workpiece is fixed by a jig; a pair of guide portions provided on both sides of an upper surface of the base portion and extending in a length direction of the base portion; a gantry portion moving toward a work location along the guide portion; a machining portion coupled to the gantry portion, moving toward the work position along a length direction of the gantry portion, and machining the workpiece; a machining support portion vacuum-adsorbing and supporting a lower surface of a machining region of the workpiece on which machining is performed by the machining portion; a guide portion provided in an internal region of the pair of guide portions and coupled to be movable toward the work position as the machining support portion slides along an upper surface thereof; and an auxiliary support portion provided on a lower surface of the machining region of the workpiece to additionally support the workpiece together with the machining support portion.

The machining support portion may have a cylindrical shape, may be disposed on a lower surface of the machining region of the workpiece, and may have at least one vacuum hole in a direction perpendicular to a lower surface of the workpiece so that the workpiece is fixed by vacuum-adsorption.

The vacuum hole may be connected to a vacuum pump and vacuum-adsorbed with the workpiece to maintain a vacuum force with the workpiece.

The machining support portion may be formed of a silicone or rubber material and maintain a vacuum state with the workpiece through a sealing force of silicone or rubber.

In order to prevent a reduction in bearing power of the machining support portion due to a deformation of the machining support portion during machining of the workpiece, an auxiliary support portion may be provided in a direction perpendicular to a lower surface of the machining region of the workpiece on an inner side of the machining support portion.

The auxiliary support portion may be provided to support the workpiece inside a vacuum hole formed on an inner side of the machining support portion, and at least one auxiliary support portion may be provided to correspond to at least one vacuum hole.

In order to prevent a reduction in bearing power of the machining support portion due to a deformation of the machining support portion during machining of the workpiece, at least one auxiliary support portion may be provided be perpendicular to a lower surface of the machining region of the workpiece on an outer side of the machining support portion and in a direction parallel to the machining support portion.

The auxiliary support portion and the machining support portion may have a length ratio of 9:10 to support the workpiece in case of a deformation of the machining support portion.

The guide portion may include: a first rail provided on the base portion and extending in a length direction of the base portion; and a second rail coupled to an upper side of the first rail and extending in a width direction of the base portion, wherein the second rail may be coupled to slide along the upper surface of the first rail so as to be movable to a work position.

The machining support portion may be coupled to an upper side of the second rail to slide along the upper surface of the second rail so as to be movable to the work position.

The workpiece may be a CFRP.

In another aspect, a machining method using machining equipment including a flexible jig deformation preventing structure applied thereto includes: vacuum-adsorbing and supporting, by a machining support portion, a workpiece, to fix the workpiece on a base portion; moving the machining portion to a work position; machining, by the machining portion, the workpiece; an operation in which the machining support portion is deformed due to movement of the workpiece by a machining force of the machining portion; an operation in which an auxiliary support portion supports the workpiece so that the workpiece does not escape due to the deformed machining support portion; and an operation in which machining of the machining portion is terminated and the machining portion is moved to an original position.

The machining support portion may include a vacuum hole therein, and the workpiece may be vacuum-adsorbed and supported through the vacuum hole.

In order to prevent a reduction in bearing power of the machining support portion due to a deformation of the machining support portion during machining of the workpiece, an auxiliary support portion may be provided in a direction perpendicular to a lower surface of the machining region of the workpiece on an inner side of the machining support portion.

The auxiliary support portion may be provided to support the workpiece inside a vacuum hole formed on an inner side of the machining support portion, and at least one auxiliary support portion may be provided to correspond to at least one vacuum hole.

In order to prevent a reduction in bearing power of the machining support portion due to a deformation of the machining support portion during machining of the workpiece, at least one auxiliary support portion may be provided be perpendicular to a lower surface of the machining region of the workpiece on an outer side of the machining support portion and in a direction parallel to the machining support portion.

Machining equipment employing the flexible jig deformation preventing structure may be a machining system using machining equipment including a flexible jig deformation preventing structure applied thereto including a system employing a flexible jig deformation preventing structure to machine a workpiece having a freeform surface.

### ADVANTAGEOUS EFFECTS

According to the present disclosure having the configuration as described above, machining quality for a machining target may be improved by minimizing vibrations occurring during machining of each machining region, deformation of a shape of the machining region, and a position error of the machining region by selecting a machining path in consideration of the number of fixing jigs and a distance between jigs at each machining region.

The effects of the present disclosure are not limited to the above effects and should be understood to include all effects that may be inferred from the detailed description of the present disclosure or the configuration of the invention described in the claims.

### BRIEF DESCRIPTION OF THE DRAWINGS

FIG. 1 is a schematic diagram of a CFRP machining method according to the related art.

FIG. 2 is a schematic diagram of a machining get machined using a carbon fiber reinforced plastic (CFRP) machining method according to the related art.

FIG. 3 is a schematic diagram of a machining target machined using a CFRP machining method according to an embodiment of the present disclosure.

FIG. 4 is a perspective view of machining equipment to which a flexible jig deformation preventing structure according to an embodiment of the present disclosure is applied.

FIG. 5 is a front view of machining equipment to which a flexible jig deformation preventing structure according to an embodiment of the present disclosure is applied.

FIG. 6 is an enlarged view of A of FIG. 5 according to an embodiment of the present disclosure.

FIG. 7 is an enlarged view of A of FIG. 5 according to another embodiment of the present disclosure.

FIG. 8 is a block diagram of a machining method using machining equipment to which a flexible jig deformation preventing structure according to an embodiment of the present disclosure is applied.

### DESCRIPTION OF EMBODIMENTS

The present disclosure includes: i) an operation in which shape data of a machining target is input to a controller; ii) an operation in which a position of each of a plurality of flexible jigs is controlled; iii) an operation in which when the machining target is seated on the flexible jig, position information of the machining target in contact with each of the flexible jigs is generated and transferred to the controller; iv) an operation in which the controller generates a machining path according to a start machining region and a machining order for the machining target by comparing the input position of the flexible jig with position and shape data of the machining target; and v) performing machining, by a tool, on the machining target, wherein, in the operation iv), the controller transfers a control signal to the tool 30 so that machining may be performed, starting from a machining region in which the smallest vibration occurs, when each machining region of the machining target is machined.

Hereinafter, the present disclosure will be described in detail with reference to the attached drawings. As those skilled in the art would realize, the described embodiments may be modified in various different ways, all without departing from the spirit or scope of the present disclosure, the drawings and description are to be regarded as illustrative in nature and not restrictive. Like reference numerals designate like elements throughout the specification.

Throughout this specification and the claims that follow, when it is described that an element is “connected (accessed, contact, and coupled)” to another element, the element may be “directly connected” to the other element and “indirectly connected” to the other element through a third element. In addition, unless explicitly described to the contrary, the word “comprise” and variations such as “comprises” or “comprising” will be understood to imply the inclusion of stated elements but not the exclusion of any other elements.

Terms used in the present application are used for describing a specific embodiment and do not limit the present disclosure. When using in a description of the present disclosure and the appended claims, a singular form includes a plurality of forms unless it is explicitly differently represented. Further, in this specification, a term “comprise” or “have” indicates presence of a characteristic, numeral, step, operation, element, component, or combination thereof described in the specification and does not exclude presence or addition of at least one other characteristic, numeral, step, operation, element, component, or combination thereof.

Hereinafter, embodiments according to the present disclosure will be described in detail with reference to the accompanying drawings.

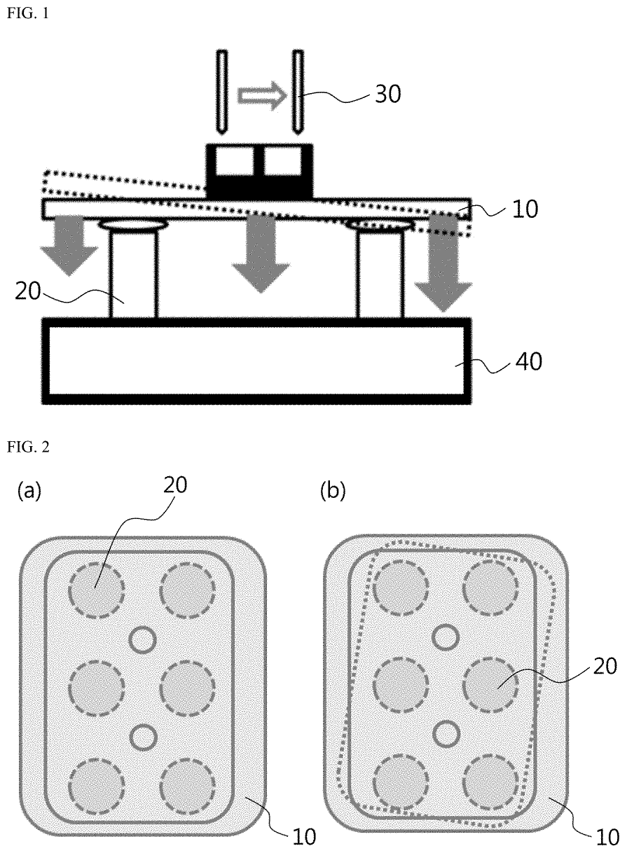

FIG. 1 is a schematic diagram of a carbon fiber reinforced plastic (CFRP) machining method according to the related art, and FIG. 2 is a schematic diagram of a machining target 10 machined using a CFRP machining method according to the related art. Here, (a) of FIG. 2 illustrates a machining target 10 before machining in the CFRP machining method according to the related art, and (b) of FIG. 2 illustrates the machining target 10 during machining in the CFRP machining method according to the related art. As shown in FIG. 1, when machining is performed on the machining target 10 using the CFRP machining method according to the related aft, a tool 30 provides a force to the machining target 10, while moving, and the machining target 10 may be deformed in shape or changed in position. The present disclosure may be devised to prevent a degradation of machining precision due to the deformation of the shape or the change in position of the machining target 10 occurring during machining as described above.

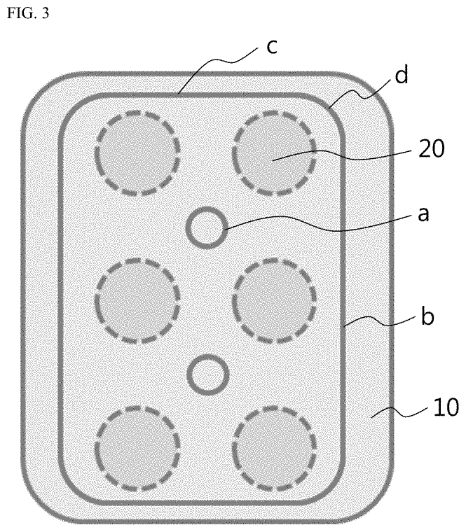

FIG. 3 is a schematic diagram of the machining target 10 machined using a CFRP machining method according to an embodiment of the present disclosure. Hereinafter, each step of the CFRP machining method of the present disclosure will be described. Here, the machining target 10, a flexible jig 20, a tool 30, and a driver 40 may be the same as the machining target 10, the flexible jig 20, the tool 30, and the driver 40 in the CFRP machining method according to the related art.

In a first step, shape data of the machining target 10 may be input to a controller. Here, in the step of inputting data of the machining target, the data of the machining target may be designed by a CAD program. The machining target 10 may include carbon fiber reinforced plastic (CFRP) having a freeform surface shape, metal, a synthetic resin, and the like. Since the shape data of the machining target 10 has a freeform surface shape, the data of the machining target may be data designed by a 3D program such as CAD or Solidworks.

In a second step, a position of each of a plurality of flexible jigs 20 may be controlled. Here, in a state in which the machining target 10 is seated on the plurality of flexible jigs 20, positions of the X, Y, and Z axes of each flexible jig 20 may be coordinated and input to the controller.

The machining target 10 on which a predetermined machining process is to be performed may be seated on the plurality of flexible jigs 20, and the flexible jigs 20 may stably support the machining target 10. In addition, the flexible jig 20 may be configured to be moved in the X-axis and the Y-axis by the driver 40 installed on a lower side of the flexible jig 20 and to rise or fall in the Z-axis. The flexible jig 20 may be formed in a cylindrical shape, but is not limited thereto.

In a third step, when the machining target 10 is seated on the flexible jig 20, position information of the machining target 10 in contact with each flexible jig 20 may be generated and transferred to the controller. Here, the controller may transmit a control signal to the tool 30 such that machining regions are machined, starting from a machining region in which the smallest vibration occurs during machining, among machining regions of the machining target 10.

The flexible jig 20 may include a contact sensor at an upper end thereof to detect a contact state with the machining target 10. The contact sensor may be any one selected from among a contact type sensor that directly contacts the machining target 10 or a non-contact type sensor that detects the machining target 10 without contacting the machining target 10, as long as the contact state with the machining target 10 can be recognized. In addition, other types of sensors may be used depending on the method of recognizing a measurement position of the machining target 10.

In a fourth step, the controller may compare an input position of the flexible jig 20 with position and shape data of the machining target 10 and generate a machining path according to a starting machining region and a machining order for the machining target 10. Here, the machining region in which the smallest vibration occurs may be determined using the number of fixing jigs, which is the number of the flexible jigs, surrounding the machining region and a jig separation distance which is a distance between the machining region or each of the flexible jigs and the machining region. Here, the jig separation distance may be an average value for each distance between each flexible jig 20 and the machining region.

The controller may analyze the position and shape of the machining region of each machining target 10 for machining of the machining target 10 and derive the number of fixing jigs around each machining region and a jig separation distance to each flexible jig 20. In addition, the controller may allow a machining region having the largest number of fixing jigs to be machined with priority, and when the number of fixing jigs is equal, the controller may allow a machining region having the smallest jig separation distance to be machined with priority. Here, a machining region machined with the highest priority may be a starting machining region, and a path from the starting machining region to the last machining region which is machined lastly may be a machining path. Since the number of flexible jigs 20 supporting the machining target 10 is provided to the maximum, an occurrence of a machining region vulnerable to vibration or the like due to an excessively large jig separation distance may not be taken into consideration. In this manner, by selecting the machining path in consideration of the number of fixing jigs and the jig separation distance of each machining region, vibration occurring during machining of each machining region, shape deformation of the machining region, and a position error of the machining region may be minimized to improve machining quality for the machining target 10.

Specifically, as shown in FIG. 3, the machining target 10 may have two machining regions a for hole machining, two machining regions b and two machining regions c for straight cutting, and four machining regions d for curved cutting. Also, in the comparison of the number of fixing jigs, the number of fixing jigs in the machining region a may be 4, the number of fixing jigs in the machining region b may be 3, the number of fixing jigs in the machining region c may be 2, and the number of fixing jigs in the machining region d may be 1. When the machining path is formed according to the above criteria, the machining order may be in an order of the machining region a, the machining region b, the machining region c, and the machining region d.

In the machining target 10, machining conditions for each machining region may be different. Here, the machining conditions may include a moving speed of the tool 30, a speed of the tool 30 itself, a machining angle of the tool 30, and the like. Specifically, machining for the machining regions a to d is based on the moving speed of the tool 30 for machining the machining region b and the speed of the tool 30 itself, a moving speed of the tool 30 at the machining region a may be relatively reduced and the speed of the tool 30 itself may be relatively accelerated. In addition, the machining conditions for the machining region c may be the same as the machining conditions for the machining region b. In addition, in the machining region d, the moving speed of the tool 30 may be relatively reduced and the speed of the tool 30 itself may be relatively reduced. This may be due to the need to minimize vibration during machining because the adjacent machining region b is cut and the number of fixing jigs is 1 in the machining region d.

The fourth step described above may include an error detection step of detecting an error in the machining process by comparing the shape data of the machining target 10 on the coordinates in contact with the flexible jig 20 with designed data. In addition, the fourth step described above may include a deformation correction step of correcting a deformation of the machining target 10 during the machining process. Here, in the deformation correction step, a machining load and vibration using the flexible jig 20 may be measured, and a deformation of the machining target 10 due to the machining load and vibration may be corrected. Specifically, the machining target 10 may be deformed due to external force, air pressure, vibration, etc. during the machining process, and as described above, the controller may continuously compare the position and machining path of the machining target 10 analyzed by the controller with the preset shape data of the machining target in real time, and if there is an error such as a position error or shape deformation of the machining target 10, the controller may analyze the position error and the shape deformation of the machining target 10 to derive a deformation of the machining target 10. In addition, the controller may transfer a control signal for correcting the deformation to the flexible jig 20, so that the deformation of the machining target 10 may be corrected.

In a fifth step, the tool 30 may perform machining on the machining target 10. In addition, the machining process for the machining target 10 may include at least one of milling, drilling, trimming, water jet, and routing.

Hereinafter, the CFRP machining apparatus of the present disclosure will be described. The CFRP machining apparatus of the present disclosure includes: a tool 30 performing machining on a machining target 10; a flexible jig 20 allowing the machining target to be seated thereon and supporting the machining target 10, and varied in length to change a position of the machining target 10; a driver 40 coupled to a plurality of flexible jigs 20 and changing a position of each of the flexible jigs 20; and a controller transferring a control signal to the flexible jig 20, the driver 40, or the tool 30 and receiving shape data for the machining target. Here, the controller transfers a control signal to the tool 30 so that machining may be performed, starting from a machining region in which the smallest vibration occurs, when each machining region of the machining target is machined. Here, the controller generates a machining path according to a start machining region and a machining order for the machining target 10 by comparing the input position of the flexible jig 20 with position and shape data of the machining target 10.

A cutting process system including the CFRP machining apparatus of the present disclosure as described above may be constructed.

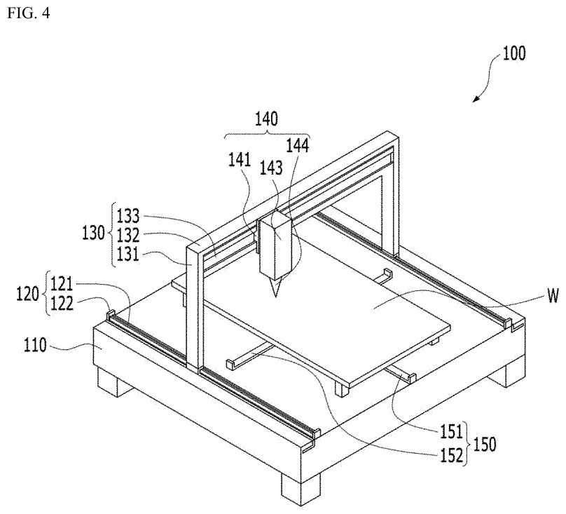

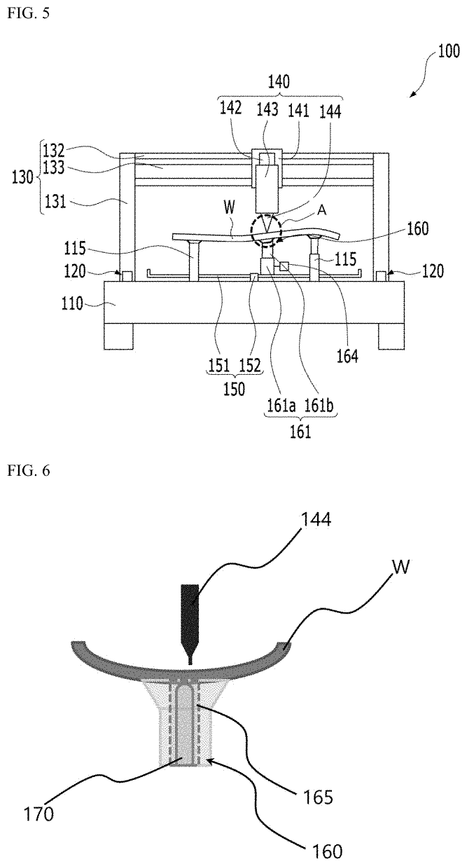

In addition, FIG. 4 is a perspective view of a machining equipment to which a flexible jig deformation preventing structure is applied according to an embodiment of the present disclosure, and FIG. 5 is a front view of a machining equipment to which a flexible jig deformation preventing structure is applied according to an embodiment of the present disclosure, and FIG. 6 is an enlarged view of A of FIG. 5 according to an embodiment of the present disclosure.

Referring to FIGS. 4 to 6, a machining equipment 100 to which a flexible jig deformation preventing structure according to the present disclosure is applied may be a complex machining equipment 100 having a machining support portion according to an embodiment. As shown in FIGS. 4 to 6, the complex machining equipment 100 having a machining support portion according to an embodiment may include a base portion 110, a guide portion 120, a gantry portion 130, a machining portion (or a machining unit) 140, a guide portion 150, and a machining support portion 160.

The base portion 110 may have a fiat top surface and may be provided in a hexahedral shape as illustrated. However, the base portion 110 is not limited to the illustrated shape and may have any shape as long as the workpiece W thereon is fixed by a jig 115. Here, the workpiece W refers to a target machined by the complex machining equipment 100 having a machining support portion. Here, the workpiece W may be a carbon fiber reinforced plastic (CFRP) material. The CFRP material may be used to include CFRP, glass fiber reinforced plastic (GFRP), dyneema fiber reinforced plastics (DFRP), zylon fiber reinforced plastics (ZFRP), boron fiber

reinforced plastics (BFRP), Kevlar fiber reinforced plastics (KFRP), carbon fiber reinforced metal (CFRM), etc.

In addition, the jig 115 may be provided to be adjustable in height so as to be in tight contact with a lower surface of the workpiece W having a curved surface to support the workpiece W. A specific configuration and shape of the jig 115 may be provided similar to the machining support portion 160 to be described later. In addition, the jig 115 may be provided at each corner of the workpiece W to fix the workpiece W. However, preferably, the jig 115 is provided in a minimum number to fix the workpiece W and selected in position such that the machining support portion 160 is easy to move under the workpiece W, but the position and the number of the jig 115 are not specifically limited.

The guide portion 120 is provided on an upper surface of the base portion 110 and includes a guide rail 121 provided to extend in a length direction of the base portion 110. Here, the guide portion 120 may be provided as a pair on both sides of the base portion 110, and in particular, may be provided at positions corresponding to lower surfaces of the gantry portion 130 to be described later. In addition, the guide rail 121 may be provided so that the gantry portion 130 may slide and move in the length direction of the base portion 110 in a state coupled to the gantry portion 130. In addition, stoppers 122 may be further provided at both ends of the guide rail 121. The stoppers 122 may be provided to protrude upward to prevent the gantry portion 130 from escaping from the guide rail 121. However, the shape of the stoppers 122 is not limited to the illustrated shape, and the stoppers 122 may have any shape as long as the stoppers 122 can prevent the gantry portion 130 from escaping from the guide rail 121.

The gantry portion 130 may be provided to be coupled to the guide portion 120 so as to be movable in the length direction of the base portion 110 toward a work position. Specifically, the gantry portion 130 is coupled to the guide rail 121 and provided so as to be slidable in the length direction of the base portion 110, and includes a vertical member 131, a horizontal member 132, and a linear guide 133.

The vertical member 131 may be coupled such that a lower end thereof is slidable on the guide rail 121. In addition, the vertical member 131 may be provided as a pair and coupled to the guide rails 121 provided as a pair, respectively. In addition, the horizontal member 132 may be provided to connect the vertical members 131 horizontally. That is, the gantry portion 130 including the vertical member 131 and the horizontal member 132 is provided in a form in which a lower surface thereof is open in a rectangular frame having a hollow therein. However, the shape of the gantry portion 130 is not limited to the illustrated shape. The linear guide 133 may be provided on a front surface of the horizontal member 132 and may extend in a length direction of the horizontal member 132. In addition, the linear guide 133 may be provided so that the machining portion 140 is coupled thereto, and the linear guide 133 may be provided such that the machining portion 140 slidably moves to a work position along a length direction of the horizontal member 132.

The machining portion 140 is provided to move in the length direction of the gantry portion 130 toward the work position to machine the workpiece W and includes a horizontal moving member 141, a machining portion body 143, and a cutting unit 144.

The horizontal moving member 141 may be coupled to the linear guide 133 of the gantry portion 130 so as to be movable in the length direction of the horizontal member 132. In addition, the horizontal movable member 141 may be provided with an elevation hole 142 to allow the machining portion body 143 to ascend or descend along the elevation hole 142.

The machining portion body 143 forms an appearance of the machining portion 140, and the shape of the machining portion body 143 is not limited to a rectangular column shape as illustrated and may have various shapes. In addition, the machining portion body 143 may slide along the elevation hole 142 and may be coupled to the elevation hole 142 so as to ascend or descend. However, ascending and descending of the machining portion body 143 is not limited thereto and may include any structure in which the machining portion body 143 is allowed to ascend and descend.

The cutting unit 144 may be mounted inside the machining portion body 143 and may be provided to extend downward. The cutting unit 144 may be a cutting tool including a bite or a tip and may be cutting, routing, drilling (CRD) equipment. That is, the cutting unit 144 may include any equipment capable of performing hole machining or the like on the workpiece W.

The guide portion 150 may be provided in an internal region of the pair of guide portions 120 and may be coupled such that the machining support portion 160 slides on an upper surface so as to be movable toward the work position. In addition, the guide portion 150 includes a first rail 151 and a second rail 152.

The first rail 151 is provided to extend in the length direction of the base portion 110 on an upper surface of the base portion 110, and may be provided in the internal region of the pair of guide portions 120. In addition, the first rail 151 may be provided so that the second rail 152 is slidable in the length direction. The second rail 152 may be coupled to an upper side of the first rail 151 and may be provided to extend in a width direction of the base portion 110. In this case, the second rail 152 may be provided to be slidable on the upper side of the first rail 151 in the length direction of the first rail 151, in addition, the machining support portion 160 is provided above the second rail 152, and the machining support portion 160 may be coupled to the second rail 152 so as to be slidable in the length direction of the second rail 152 on the upper surface of the second rail 152. That is, the machining support portion 160 may be moved to the work position by the first rail 151 and the second rail 152.

However, the shape of the guide portion 150 for transferring the machining support portion 160 is not limited to the embodiment, and the machining support portion 160 may be provided to be movable by magnetic levitation or a robot.

The machining support portion 160 supports a lower surface of a machining region of the workpiece W machined by the machining portion 140, and includes a body unit 161, a fixing unit 162, a connection unit 163 and a first control unit 164.

The main unit 161 is coupled to the guide portion 150, slides to the work position, and is adjustable in length. Specifically, the body unit 161 includes a first body 161a and a second body 161b. The first body 161a is coupled to an upper side of the second rail 152 and is provided to be slidable in a length direction of the second rail 152 toward the work position. The second body 161b may be provided to extend upward from the first body 161a. For example, the second body 161b may be provided in the form of a multi-stage boom with the first body 161a or the machining support portion 160 may support the workpiece W to correspond to a height of the workpiece W by adjusting a length of the body unit 161.

In addition, the machining equipment 100 to which a flexible jig deformation preventing structure according to the present disclosure is applied may include a base portion 110 to which a workpiece is fixed by a jig, a pair of guide portions 120 provided on both sides of an upper surface of the base portion and extending in a length direction of the base portion 110, a gantry portion 130 moving toward a work position along the guide portion 120, a machining portion 140 coupled to the gantry portion 130, provided to move toward the work position in the length direction of the gantry portion 130, and machining the workpiece, a machining support portion vacuum-adsorbing and supporting a lower surface of a machining region of the workpiece W to he machined by the machining portion 140, a guide portion 150 provided in an internal region of the pair of guide portions 120 and coupled such that the machining support portion 160 sliding on an upper surface so as to be movable toward the work position, and an auxiliary support portion 170 provided on a lower surface of the machining region of the workpiece to additionally support the workpiece together with the machining support portion 160.

In addition, the machining support portion 160 may have a cylindrical shape, may be disposed on a lower surface of the machining region of the workpiece, and may include at least one vacuum hole 165 in a direction perpendicular to a lower surface of the workpiece.

More specifically, the vacuum hole 165 is disposed on a lower surface of the machining region of the machining target to fix the machining target, is formed inside the machining support portion 160 formed in the cylindrical shape, and is disposed in a direction perpendicular to the lower surface of the surface to fix the workpiece through vacuum adsorption.

In addition, the vacuum hole 165 may be connected to a vacuum pump (not shown) to maintain a vacuum force with the workpiece to be vacuum-adsorbed with the workpiece.

In more detail, the vacuum hole 165 may be connected to a vacuum pump to operate the vacuum pump to fix the workpiece in a vacuum adsorption manner. Accordingly, the vacuum hole 165 maintains the vacuum force through the vacuum pump to fix the workpiece.

In addition, the machining support portion 160 may be formed of a silicone or rubber material and may maintain a vacuum state with the workpiece through a sealing force of the silicone or rubber.

More specifically, the machining support portion 160 may be formed of a silicone or rubber material to maintain a vacuum state with the workpiece, and may maintain a sealing force using the properties of the silicone or rubber.

In addition, the auxiliary support portion 170 may be provided in a direction perpendicular to a lower surface of the machining region of the workpiece on an inner side of the machining support portion 160 to prevent a reduction in bearing power of the machining support portion 160 due to a deformation of the machining support portion 160 in the case of machining the workpiece.

More specifically, the auxiliary support portion 170 is disposed in the vacuum hole 165 inside the machining support portion 160, and when the workpiece vacuum-adsorbed through the vacuum hole 165 is deformed by a machining force, the auxiliary support portion 170 may additionally support the workpiece so that the workpiece may be normally machined.

In addition, the auxiliary support portion 170 may be provided to support the workpiece in the vacuum hole 165 formed inside the machining support portion 160, and at least one auxiliary support portion 170 may be provided to correspond to at least one vacuum hole 165.

More specifically, a plurality of vacuum holes 165 may be formed in the machining support portion 160 for stable fixing of the workpiece and a plurality of vacuum holes 165 may be formed in the plurality of vacuum holes 165 to stably support the workpiece.

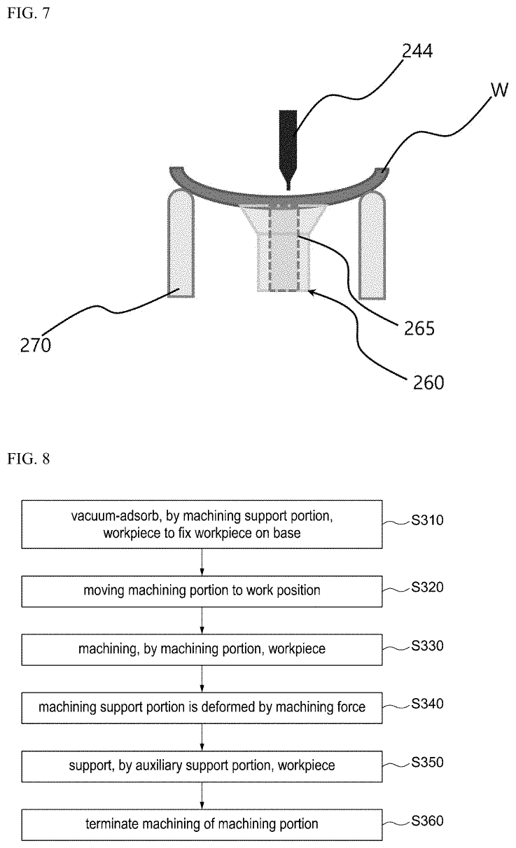

FIG. 7 is an enlarged view of A of FIG. 5 according to another embodiment of the present disclosure.

Referring to FIG. 7, at least one auxiliary support portion 270 may be provided in a direction perpendicular to a lower surface of the machining region of the workpiece and parallel to the machining support portion 260 outside the machining support portion 260 to prevent a reduction in bearing power of the machining support portion 260 due to a deformation of the machining support portion 260 when the workpiece W is machined.

More specifically, at least one auxiliary support portion 270 may be disposed in a direction perpendicular to a lower surface of the machining region of the workpiece and parallel to the machining support portion 160 to support the workpiece when bearing power of the machining support portion 260 is reduced due to a deformation of the machining support portion 260 when the workpiece is machined.

Referring to FIGS. 4, 5, and 7, the auxiliary support portions 170 and 270 and the machining support portions 160 and 260 may have a length ratio of 9:10 in order for the auxiliary support portions 170 and 270 to support the workpiece when the machining support portions 160 and 260 are deformed.

More specifically, the machining support portions 160 and 260 may be deformed by a machining force from the machining portion 140, and accordingly, bearing power supporting the workpiece may be reduced and machining may not be normally performed. Therefore, the auxiliary support portions 170 and 270 and the machining support portions 160 and 260 may be formed in the length ratio of 9:10 so that the auxiliary support portions 170 and 270 support the workpiece when bearing power of the machining support portions 160 and 260 is reduced.

Referring to FIGS. 4 to 6 and 8, a machining method using machining equipment including a flexible jig deformation preventing structure according to the present disclosure applied thereto includes: vacuum-adsorbing and supporting, by the machining support portion 160, the workpiece W, to fix the workpiece W on the base portion 110 (S310); moving the machining portion 140 to a work position (S320); machining, by the machining portion 140, the workpiece W (S330); an operation in which the machining support portion 160 is deformed due to movement of the workpiece by a machining force of the machining portion 140 (S340); an operation in which the auxiliary support portion 170 supports the workpiece so that the workpiece does not escape due to the deformed machining support portion 160 (S350); and an operation in which machining of the machining portion 140 is terminated and the machining portion 140 is moved to an original position.

In addition, the machining support portion 160 includes the vacuum hole 165 therein and may vacuum-support the workpiece through the vacuum hole 165 to support the workpiece.

In addition, the auxiliary support portion 170 may be provided in a direction perpendicular to a lower surface of the machining portion 140 of the workpiece inside the machining support portion 160 to prevent a reduction in bearing power of the machining support portion 160 due to a deformation of the machining support portion 160 when the workpiece is machined.

Referring to FIGS. 7 to 8, the auxiliary support 270 is provided in the vacuum hole 265 formed inside the machining support portion 260 to support, the workpiece, and at least one auxiliary support portion 270 may be provided to correspond to at least one vacuum hole 265.

In addition, at least one auxiliary support portion 270 may be provided in a direction perpendicular to the lower surface of the machining region of the workpiece and parallel to the machining support portion 160 outside the machining support portion 260 to prevent a reduction bearing power of the machining support portion 160 due to a deformation of the machining support portion 260 when the workpiece is machined.

In addition, the machining equipment to which the flexible jig deformation preventing structure is applied is a machining system using the machining equipment to which the flexible jig deformation preventing structure is applied with a system to which the flexible jig deformation preventing structure is applied to machine the workpiece including a freeform surface.

The foregoing description of the present invention is for an illustration, and it may be understood by a person of ordinary skill in the art that the present invention may be easily changed in different detailed forms without changing the technical spirit or an essential characteristic of the present invention. Therefore, it should be understood that the foregoing exemplary embodiments are not limited but are illustrative. For example, each constituent element described in a single type may be distributedly performed, and constituent elements described in a distributed type may be performed in a combined form.

The scope of the present invention is represented by claims to be described later, and it should be analyzed that a meaning and the scope of claims and an entire change or a changed form derived from an equivalent concept thereof are included in the scope of the present invention.

[Detailed Description of Main Elements]

10: machining target

20: flexible jig

30: tool

40: driver

100: equipment ploying flexible jig deformation preventing structure

110: base portion

120: guide portion

121: guide rail

122: stopper

130: gantry portion

131: vertical member

132: horizontal member

133: linear guide

140: machining portion

141: horizontal movement member

143: machining portion body

144, 244: cutting unit

150: guide portion

151: first rail

152: second rail

W: workpiece

160, 260: machining support portion

165, 265: vacuum hole

170, 270: auxiliary support portion

1. A method for machining a CFRP using a machining path and a machining order in view of a jig arrangement comprising:
i) an operation in which shape data of a machining target is input to a controller;
ii) an operation in which a position of each of a plurality of flexible jigs is controlled;
iii) an operation in which when the machining target is seated on the flexible jig, position information of the machining target in contact with each of the flexible jigs is generated and transferred to the controller;
iv) an operation in which the controller generates a machining path according to a start machining region and a machining order for the machining target by comparing the input position of the flexible jig with position and shape data of the machining target; and
v) performing machining, by a tool, on the machining target,
wherein, in the operation iv), the controller transfers a control signal to the tool so that machining is performed, starting from a machining region in which the smallest vibration occurs, when each machining region of the machining target is machined.

2. The method of claim 1, wherein, in operation iv), the machining region in which the smallest vibration occurs is determined using the number of fixing jigs, which is the number of the flexible jigs, surrounding the machining region and a jig separation distance which is a distance between the machining region or each of the flexible jigs and the machining region.

3. The method of claim 1, wherein, in operation i), in the operation of inputting data of the machining target, the data of the machining target is designed by a CAD program.

4. The method of claim 1, wherein, in operation ii), in a state in which the machining target is seated on the plurality of flexible jigs, positions of X, Y, and Z axes of each of the flexible jigs are formed as coordinates and input to the controller.

5. The method of claim 1, wherein the machining target includes at least one of carbon fiber reinforced plastic (CFRP), metal, or a synthetic resin having a freeform surface shape.

6. The method of claim 1, wherein, in operation v), a machining process for the machining target includes at least one of milling, drilling, trimming, water jet, or routing.

7. The method of claim 1, wherein operation iv) includes an error detection operation of detecting an error of a machining process by comparing the shape data of the machining target with designed data on coordinates in contact with the flexible jig.

8. The method of claim 1, wherein operation iv) includes a deformation correction operation of correcting a deformation of the machining target during a machining process.

9. The method of claim 8, wherein, in the deformation correction operation, a machining load and vibration are measured using the flexible jig, and a deformation of the machining target due to the machining load and the vibration are corrected.

10. A machining equipment including a flexible jig deformation preventing structure applied thereto comprising:
a base portion to which a workpiece is fixed by a jig;
a pair of guide portions provided on both sides of an upper surface of the base portion and extending in a length direction of the base portion;
a gantry portion moving toward a work location along the guide portion;
a machining portion coupled to the gantry portion, moving toward the work position along a length direction of the gantry portion, and machining the workpiece;
a machining support portion vacuum-adsorbing and supporting a lower surface of a machining region of the workpiece on which machining is performed by the machining portion;
a guide portion provided in an internal region of the pair of guide portions and coupled to be movable toward the work position as the machining support portion slides along an upper surface thereof; and
an auxiliary support portion provided on a lower surface of the machining region of the workpiece to additionally support the workpiece together with the machining support portion.

11. The machining equipment of claim 10, wherein the machining support portion has a cylindrical shape, is disposed on a lower surface of the machining region of the workpiece, and has at least one vacuum hole in a direction perpendicular to a lower surface of the workpiece so that the workpiece is fixed by vacuum-adsorption.

12. The machining equipment of claim 11, wherein the vacuum hole is connected to a vacuum pump and vacuum-adsorbed with the workpiece to maintain a vacuum force with the workpiece.

13. (canceled)

14. The machining equipment of claim 10, wherein an auxiliary support portion is provided in a direction perpendicular to a lower surface of the machining region of the workpiece on an inner side of the machining support portion, to prevent a reduction in bearing power of the machining support portion due to a deformation of the machining support portion during machining of the workpiece.

15. (canceled)

16. The machining equipment of claim 10, wherein at least one auxiliary support portion is provided be perpendicular to a lower surface of the machining region of the workpiece on an outer side of the machining support portion and in a direction parallel to the machining support portion, to prevent a reduction in bearing power of the machining support portion due to a deformation of the machining support portion during machining of the workpiece.

17. The machining equipment of claim 10, wherein the workpiece is carbon fiber reinforced plastic (CFRP).
